(19) United States
(12) Patent Application Publication
(10) Pub. No.: US 2005/0163996 A1
(43) Pub. Date: Jul. 28, 2005

(54) Adhesive compositions based on blends of grafted substantially linear polyethylenes and non-grafted conventional polyethylenes

(76) Inventors: I-Hwa Lee, Wilmington, DE (US); Barry Alan Morris, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/086,618

(22) Filed: Mar. 22, 2005

Related U.S. Application Data
(62) Division of application No. 09/494,107, filed on Jan. 28, 2000.
Application No. 09/494,107 is a continuation-in-part of application No. 08/591,330, filed on Jan. 25, 1996, now Pat. No. 6,545,091.

(51) Int. Cl. B32B 7/12

(52) U.S. Cl. 428/355 R; 525/408

(57) ABSTRACT

Laminated films comprising at least one structural layer, at least one adhesive layer and optionally at least one barrier layer made by a high speed or fast quench film process, where the adhesive compositions are blends of acid-grafted substantially linear polyethylenes and conventional-linear polyethylene homopolymer or copolymer or low density polyethylene.

This is a Divisional of U.S. application Ser. No. 09/494,107, filed Jan. 28, 2000, which is a Continuation-in-part of U.S. application Ser. No. 08/591,330, filed Jan. 25, 1996, now U.S. Pat. No. 6,545,091, issued Apr. 8, 2003.

### BACKGROUND OF THE INVENTION

1. Field of the Invention

This invention relates to laminated films comprising at least one structural layer, at least one adhesive layer and optionally at least one barrier layer made by a high speed or a fast quench film process, wherein the adhesive compositions are blends of acid-grafted substantially linear polyethylenes and conventional-linear polyethylene homopolymer or copolymer or low density polyethylene.

2. Discussion of Related Art

Co-extrudable adhesives based on blends of various polyethylenes that also contain an acid-grafted polyolefin are well known. For example, U.S. Pat. No. 3,868,433 (Bartz, et al.) discloses conventional polyolefins graft-modified with acids for use as hot-melt adhesives. U.S. Pat. No. 4,684,576 (Tabor, et al.) discloses adhesive blends based on acid-grafted high density polyethylene, and linear low density polyethylene of density 0.88 to 0.935.

Adhesives containing various conventional polyethylenes and conventional acid-grafted polyethylenes are known, and employ known linear polyethylenes such as, for example, high-density polyethylene homopolymers (conventional-HDPE), medium density polyethylene polymers (conventional-MDPE), linear low density polyethylene copolymers (conventional-LLDPE), as well as low density polyethylene (high pressure, free-radical or LDPE).

In recent years, polyethylenes have been developed which are made using metallocene catalysts, also known as “single-site” catalysts. These polyethylenes are more uniform than conventional linear polyethylenes in various aspects related to their composition. Polyethylenes obtained from processes using single-site catalysts are similar to conventional-HDPE and conventional-LLDPE in that they are essentially linear, that is, they have no, or only a modest amount of, long-chain branching. Except for the catalyst, they can be prepared in ways similar to conventional-HDPE and conventional-LLDPE. They can include an alpha-olefin comonomer. However, they are unlike free-radical LDPE, which contains large amounts of long-chain branching.

U.S. Pat. No. 5,272,236 (Lai '236) and its continuation-in-part U.S. Pat. No. 5,278,272 (Lai '272) disclose metallocene polyethylene homopolymers and copolymers. The polyethylenes of these patents are differentiated from “conventional” polyethylenes, and are referred to therein as ‘substantially linear’. The substantially linear metallocene polyethylenes of Lai can be grafted with acid comonomers such as maleic anhydride, as described in U.S. Pat. 5,346,963 (Hughes), to produce grafted substantially linear polyethylenes. In Hughes, grafted substantially linear polyethylenes are disclosed as being useful as adhesives for making polymer films.

The use of grafted substantially linear polyethylene adhesives can have problems, however. Such adhesives may possibly show deficiencies if used on high speed equipment. In extrusion and/or coextrusion processes such as (co)extrusion coating, (co)extrusion lamination or (co)extrusion cast film, it is well known that high line speeds and short air gaps are more demanding than low line speeds and long air gaps, and frequently peel strength is reduced under these more demanding process conditions. Similarly, for (co)extrusion blown film, a high line speed or increased internal bubble cooling, or the use of refrigerated gases in bubble cooling can reduce peel strengths. Also similarly, for (co)extrusion cast sheet followed by orientation, the severity of the orientation process can reduce peel strength. As used herein, the term “(co)extrusion” refers to either or both extrusion and coextrusion processes. In commercial processes however, these more demanding conditions are desired because they increase the productivity or output, and reduce the unit cost of these composite structures. Use of substantially linear polyethylenes in these processes, however, can be cost prohibitive in a commercial application.

Surprisingly, we have found that “conventional” polyethylene adhesives that include a grafted substantially linear polyethylene can provide unusually high peel strengths as compared with conventional polyethylene adhesives that include grafted conventional polyethylene.

### SUMMARY OF THE INVENTION

In one aspect, the present invention is an adhesive composition, useful in composite rapid film fabrication processes, comprising: from about 5 percent to about 35 percent, by weight, acid-grafted substantially linear polyethylenes; a conventional-linear polyethylene and/or a LDPE based adhesive composition.

In another aspect, the present invention is a composite film structure, made by a rapid film fabrication process, wherein the film structure comprises an adhesive layer, a polyolefin layer and optionally a polar resin layer, and wherein the adhesive layer comprises a blend of:
a) a polyethylene selected from the group consisting of conventional-HDPE, conventional-MDPE, conventional-LLDPE, conventional very low density polyethylene (VLDPE), LDPE or a blend of any of these five polyethylenes;
b) from about 5 to about 35 weight percent, based on the total blend of a) plus b) plus c), of an acid-grafted substantially linear polyethylene;
c) from zero to about 30 weight percent of a polyolefin elastomer, the acid grafting agent being an unsaturated carboxylic acid or its derivative, and the level of grafting being such that the total amount of grafting agent is 0.01 to 3 weight percent based on the total composition, a) plus b) plus c).

### DETAILED DESCRIPTION OF THE INVENTION

In one embodiment, the present invention is an adhesive composition useful for preparing laminate films in a rapid film fabrication process. As the term is used herein, a “rapid film fabrication process” is either a high-speed film fabrication process or a fast quench film fabrication process. A high-speed film fabrication process can be described in various ways, depending on the type of film process being used. In the case of (co)extrusion cast film, (co)extrusion coating or (co)extrusion laminating process, a high speed film process is one in which the line speed can vary from between about 50 to about 950 m/min and the air gap, which is defined in the polymer film fabrication art as the distance between the die lip and chill roll, can vary from about 10 mm to about 500 mm. Preferably, for (co)extrusion coating or (co)extrusion lamination processes, the line speed is in the range of from about 80 to about 800 m/min. More preferably the line speed is in the range of from about 100 to about 600, and most preferably from about 100 to about 400 m/min. Preferably the air gap is from about 75 to about 500 mm, more preferably from about 100 to about 450, and most preferably from about 120 to about 350 mm. The terms “die lip” and “chill roll” are known to those of ordinary skill in the art, and have their ordinary meaning as used herein. For a (co)extrusion cast film process, the line speed is preferably in the range of from about 50 to about 400 m/min. More preferably the line speed is from about 60 to about 300 m/min, even more preferably in the range of from about 70 to about 300 m/min, and most preferably in the range of from about 100 to about 250 m/min. The air gap for a (co)extrusion cast film process is in the range of from about 12 to about 100 mm, preferably in the range of from about 25 to about 75 mm.

A fast quench process can be described as a rapid (co)extrusion blown film process, wherein a hot polymer bubble is cooled by a gaseous or liquid medium such as chilled air, air containing liquefied gases, chilled water, or air at ambient temperature, for example. In a fast quench process of the present invention, the bubble is cooled in such a way that the process time is less than about 12 seconds, preferably less than about 8 seconds. More preferably less than about 6 seconds, and most preferably less than about 5 seconds. The process time can be calculated using the following equation:

$${t}_{f} = \frac{h}{{V}_{f}} \frac{DDR}{DDR - 1} ln ( DDR )$$

where t_{f}=process time
h=frost line height
V_{f}=haul-off speed
DDR=draw down ratio=V_{f}/Vₒ
Vₒ=initial velocity of the melt as it exits the blown film die.
   The frost line is defined herein as a line on the outer layer of a blown film bubble wherein the bubble film becomes translucent, that is, that point where the resin begins to solidify. In such case that the frost line is not visible, the frost line is defined as the location on the bubble where the diameter stops increasing in dimension. In a coextrusion film process, several frostlines can be present, one for each layer of the film. For the purposes of the present invention the frost line of a coextruded film will be the lowest frost line (i.e., the frost line of the layer that freezes first).

A laminate film of the present invention comprises at least one structural layer, at least one adhesive layer, and optionally at least one barrier layer. The structural layer can be selected from one or more of the following resins: linear and branched ethylene homopolymers; ethylene alpha olefin copolymers; ethylene vinyl acetate polymers; ethylene acrylic or methacrylic acid polymers and their ionomers; ethylene acrylate and methacrylate polymers; propylene homopolymers and copolymers; styrene homopolymers and copolymers; and, polyester homopolymers and copolymers. The barrier layer can be selected from one or more of the following resins: ethylene vinyl alcohol, nylon homopolymers and copolymers, polyester homopolymers and copolymers, liquid crystalline polymers, foils, metallized films, paper, and paperboard treated to provide moisture, bacterial, or viral barriers. The laminate film is not limited to the number of layers it may contain. It can further contain more than one type of barrier layer and more than one type of structural layer. There is no limitation to the different positions within the laminate where the structural and barrier layers may be placed.

The adhesive layer composition comprises a blend of:
a) a polyethylene selected from the group consisting of conventional-HDPE, conventional-MDPE, conventional-LLDPE, conventional-VLDPE, LDPE and a blend of any of these five polyethylenes;
b) from 5 to 35 weight percent, based on the total blend of a) plus b) plus c), of an acid-grafted substantially linear polyethylene,
c) optionally up to 30 percent of a polyolefin elastomer;
   the acid grafting agent being an unsaturated carboxylic acid or its derivative, and the level of grafting being such that the total amount of grafting agent is 0.01 to 3 weight percent based on the total composition, a) plus b) plus c).

The density distinguishing abbreviations HDPE, MDPE, LLDPE, VLDPE or ULDPE (ultra low density polyethylene), are used for ‘linear’ as distinct from highly branched (short and long chain) LDPE made by free-radical polymerization. For the purposes of the present application, resins made by Ziegler-Natta type catalysis will be referred to herein as conventional-HDPE, coonventional-MDPE, conventional-LLDPE, conventional-VLDPE, or conventional-ULDPE. Density ranges for the conventional-linear resins used herein are: greater than 0.950 g/cc for conventional-HDPE; from greater than 0.935 g/cc to 0.950 g/cc for conventional-MDPE; from greater than 0.91 to 0.935 g/cc for conventional-LLDPE; and, from about 0.85 to about 0.91 g/cc for conventional-VLDPE. LDPE in this disclosure is free radical polyethylene having a density from about 0.91 to about 0.935 g/cc.

Acid-grafted metallocene resins useful herein are (i) those obtained from ungrafted metallocene resins which have an I-10/I-2 ratio of less than 5.63 and an Mw/Mn (polydispersivity) of greater than (I-10/I-2)−4.63, and (ii) those based on ungrafted metallocene resins which have an I-10/1-2 ratio of equal to or greater than 5.63 and a polydispersivity equal to or less than (I-10/I-2)−4.63. Preferably the ungrafted metallocene resins of group (ii) will have a polydispersivity of greater than 1.5 but less than or equal to (I-10/1-2)−4.63. The polydispersivity of acid-grafted resins of the present invention can be different from the polydispersivity of the ungrafted resins, but can be in the range of the ungrafted resins. The polydispersivity of the blends of the present invention can vary depending on the polydispersivity of the conventional polyethylene component.

The three types of conventional-linear resins discussed above can be prepared by well known Ziegler-Natta methods (e.g., U.S. Pat. No. 4,076,698 and U.S. Pat. No. 3,645,992); catalysis in solution, slurry, gas phase, or on a support. Metallocene resins can be made using conditions well known in the prior art for continuous polymerization, Ziegler-Natta or Kaminsky-Sinn type polymerization reactions. That is to say, temperatures from 0° C. to 250° C., and pressures from atmospheric to 1000 atmospheres (100 MPa) can be used to prepare conventional resins useful herein. Suspension, solution, slurry, gas phase or other process conditions can be employed if desired. A support can be employed, but preferably the catalysts are used in a homogeneous solution.

Suitable conditions and catalysts which can produce substantially linear metallocene resins are described in U.S. Pat. No. 5,278,272, which is hereby fully incorporated by reference. The reference gives full descriptions of the measurement of the well-known rheological parameters I-10 and I-2, which are flow values under different load and hence shear conditions. It also provides details of measurements of the well-known Mw/Mn ratio determination, as determined by gel-permeation chromatography (GPC). Ungrafted metallocene resins suitable for use in the present invention are also described in U.S. Pat. Nos. 5,198,401 and 5,405,922 which are also hereby fully incorporated by reference. While metallocene catalysts can be useful to prepare the substantially linear polymers described herein, substantially linear polyethylene polymers prepared by other processes can also be useful in the practice of the present invention. References to metallocene-generated substantially linear polymers does not exclude the use of substantially linear polyethylenes generated by any method now known, or any method not yet known.

Surprisingly, although the superior properties of metallocene resins and acid-grafted metallocene resins depend on the narrow molecular weight distribution and, for copolymers, on the uniformity of short-chain branching both along chains and from chain to chain, it has been found that these resins can undergo major dilution with conventional linear polyethylenes and LDPE, and optionally elastomer. The adhesive compositions of this invention comprise from about 5 to about 35 weight percent, preferably from about 5 to about than 30 weight percent, and most preferably from about 8 to about 25 weight percent of acid-grafted metallocene resins.

The blends of the present invention comprise from about 65 to about 95 weight percent of a non-grafted resin that is a conventional-linear polyethylene, a mixture of conventional-linear polyethylenes, LDPE, or a mixture of any of these. From 0 to about 30 weight percent, based on the total weight of the blend, of the non-grafted portion of the adhesive blends of the present invention can be a hydrocarbon elastomer. The resins of the non-grafted portion with conventional-linear polyethylene and/or LDPE and optionally elastomer can have a broad molecular weight distribution, and therefore, the blend compositions can also have a broad molecular weight distribution.

Blends of the present invention can be prepared by any method that is known and conventional in the art. For example, blends can be prepared by dry blending solid polymer components before extrusion. Blends can be prepared by melt blending (or melt mixing), wherein a dry blended mixture is melted and mixed in an extruder that is designed to give good mixing of coextruded polymers. It can also be conventional to melt mix a dry blended mixture using an extruder that is not designed to thoroughly mix the dry blend. Any method for blending polymers known or conventional can be used in the practice of the present invention.

All or part of the metallocene polyethylene can be graft-modified with an unsaturated carboxylic acid or its derivatives. Suitable acid grafting agents include: acrylic acid, methacrylic acid, fumaric acid, maleic acid, nadic acid, citraconic acid, itaconic acid, and similar compounds. Anhydrides, metal salts, esters amides, imides, and like compounds derivable from the above acids are also suitable. The preferred grafting agents are maleic acid and maleic anhydride. Maleic anhydride is most preferred.

Any method known in the art for grafting onto the metallocene polyethylene can be used herein. For example, grafting can be carried out in the melt without a solvent, as disclosed in European Patent Application No. 0,266,994, or in solution or dispersion or in a fluidized bed. Melt grafting can be done in a heated extruder, a Brabender® or a Banbury® mixer or other internal mixers or kneading machines, roll mills and the like. The grafting can be carried out in the presence or absence of a radical initiator such as a suitable organic peroxide, organic perester, or organic hydroperoxide. The grafted polymers are recovered by any method that separates or utilizes the graft polymer that is formed. Thus, the graft polymer can be recovered in the form of precipitated fluff, pellets, powders and the like.

In grafting the metallocene resin, all or some of metallocene can have an acid graft or grafts. However, the art of grafting uniformly is well known, and the acid-grafted resin should be as uniformly grafted as possible. The amount of graft, that is the amount of grafting agent that remains with the metallocene resin, is such that the total adhesive composition contains from about 0.005 to about 5 weight percent, preferably from about 0.01 to about 3 weight percent, more preferably from about 0.03 to about 0.5 weight percent, and most preferably from about 0.05 to about 0.25 weight percent of acid grafts. It is within the skill of the artisan to achieve satisfactory uniformity of the grafting for any given level of total grafting, including further blending the grafts of the present invention with ungrafted metallocene polyethylenes, so long as suitable uniformity is not compromised.

The density of the metallocene resin to be grafted can be from 0.85 to 0.96 g/cc. It can be a homopolymer or a copolymer. Metallocene elastomer olefin copolymers can also be suitable for use in the present invention. The lower density can correspond to more than 30 weight percent comonomer depending upon the comonomer. These density limits can include mixtures that include elastomers. The comonomer can be an alpha olefin containing from 3 to 20 carbons, preferably 3 to 12 and most preferably from 3 to 8. Examples include propylene, 1-butene, 1-hexene, 4-methyl-1-pentene, 1-octene, and 1-decene. Propylene, 1-hexene, 1-butene and 1-octene are preferred. The density of several suitable copolymers and the amounts of which comonomer they contain are shown in Table 2 and Table 3.

The melt index (MI), as measured according to ASTM D-1238, at 190° C. using a load of 2.16 kg (the conditions of the I-2 measurement), of the grafted metallocene copolymer can be from about 0.1 to about 50, preferably about 0.3 to about 40. It should be understood that in the practice of the present invention the acid-grafted metallocene polyethylene can be a mixture of polyethylenes, each having a unique melt index, and each having a a unique grafting level, and each being derived from more than one starting (i.e., ungrafted) metallocene resin.

The ungrafted conventional-linear polyethylene, which can be conventional-HDPE, conventional-LLDPE, conventional-MDPE, conventional-VLDPE, or LDPE, or mixtures of any of these, and optionally up to about 30 weight percent of a hydrocarbon elastomer. Adhesive compositions wherein the graft resin is acid-grafted conventional-linear homopolymer or copolymer polyethylene or acid-grafted LDPE are well known in the art.

The adhesive blends of this invention can be prepared by known techniques, including melt blending by batch or continuous mixing. For example, the blends can be prepared by melt extrusion in a single or twin screw extruder, or by using mixing devices such as a Banbury or roll mill. The blends may be melt mixed before being coextruded, or they can be dry blended and melt-mixed during the coextrusion process.

The density of a final adhesive blend composition can be in the range of from about 0.88 g/cc to about 0.96 g/cc. The density of any component of the blend can range anywhere from about 0.85g/cc to about 0.97g/cc. Higher density adhesives can be more useful for high temperature end uses or for high moisture barrier end uses. Adhesive compositions with a lower overall density will, in general, show higher peel strengths at ambient temperatures than higher density compositions. It is possible to achieve a given density adhesive by blending any number of different combinations of components of various densities. The density of an acid-grafted resin can be quite critical to the resin properties.

A (non-grafted) hydrocarbon elastomer is optionally a component of the adhesive. Such elastomers are well known as optional components in non-metallocene resin-containing polyethylene based adhesives. The elastomers are preferably uncured, particularly when the final compositions are to be readily melt-extrudable.

For the purposes of this invention, a hydrocarbon elastomer useful herein is an elastomer having a heat of fusion below about 30 joules/gram. The heat of fusion of an elastomer useful herein can be below 10 joules/gram, and can even have no measurable heat of fusion at all.

A hydrocarbon elastomer of the present invention can be a copolymer of ethylene and one or more alpha-olefins selected from the group consisting of: propylene; 1-butene; 1-pentene; 1-hexene; 1-octene; 4-methyl-1-pentene; 1,4-butadiene; and 1,4-hexadiene. Examples of such elastomers would be ethylene propylene rubber, ethylene propylene diene rubber (EPDM), and ethylene propylene norbornene rubber. The elastomer can also be styrene-butadiene thermoplastic rubber and styrene-isoprene thermoplastic rubber. Less preferably small amounts of a cross-linked rubber are possible, such as butyl rubber or polyisobutylene. The elastomer will generally be made using conventional catalysts using methods well known in the art. However, elastomers made using metallocene catalysts are not excluded.

### EXAMPLES

The adhesive blend compositions in the following examples were prepared by blending the dry ingredients together in a tumbling mixer, and subsequently melt blending them in a single screw 63.5 mm HPM extruder. Melt temperature was typically 200 to 220° C.

The adhesive blend compositions were coextruded in four different processes. The processes are described in detail below.

In Process A, the adhesive blend compositions were co-extruded between an inner and outer layer of conventional-LDPE of melt index 7 g/10 minutes and density 0.918 g/cc, and either a layer of ethylene/vinyl alcohol (EVOH) containing 44 mole % ethylene and a melt index of 5.5 g/10 min or a layer of nylon 6 with a melt flow index (as measured by ASTM D1238 at 235° C. using a 1000 g load) of 4.5 g/10 min. For the EVOH containing structures, the LDPE was melted at 260° C. in a 114 mm single screw extruder operating at 133 rpm. The adhesive blends were melted at 238° C. in a 63.5 mm single screw extruder operating at 133 rpm. The EVOH was melted at 232° C. in a 63.5 mm single screw extruder operating at 75 rpm. All three melt streams were combined in an ER-WE-PA feedblock and fed together through a Cloeren bead reduction die at 252° C. to coextrusion coat onto a 48 gauge Mylar® film threaded through the chill rolls so as to form a 5-layer film coated onto Mylar® with the LDPE at 10 microns against the Mylar® film side and 15 microns on the air side, the adhesive layers at 2.5 microns and the EVOH layer at 5.1 microns. The line speed was 243.8 m/min and the air gap or distance between the die and the chill roll was 127 mm. For the nylon 6 containing structures, the LDPE was melted at 291° C. in a 114 mm single screw extruder operating at 135 rpm. The adhesive blends were melted at 274° C. in a 63.5 mm. single screw extruder operating at 138 rpm. The nylon was melted at 266° C. in a 63.5 mm single screw extruder operating at 85 rpm. All three melt streams were combined in an ER-WE-PA feedblock and fed together through a Cloeren bead reduction die at 266° C. to coextrusion coat onto a 48 gauge Mylar® film threaded through the chill rolls so as to form a five layer film with the LDPE at 10 microns against the Mylar® film side and 15 microns on the air side, the adhesive layers at 2.5 microns and the nylon layer at 5.1 microns.

In Process B, the adhesive blend compositions were co-extruded between an inner and outer layer of conventional-LDPE of melt index 7 g/10 minutes and density 0.918 g/cc, and a layer of ethylene/vinyl alcohol (EVOH) containing 44 mole % ethylene and a melt index of 5.5 g/10 min. The outer LDPE layer was melted at 193° C. in a 50.8 mm single screw extruder operating at 73 rpm. The inner LDPE layer was melted at 193° C. in a 63.5 mm single screw extruder operating at 28 rpm. The adhesive blends were melted at 227° C. in a 50.8 mm. single screw extruder operating at 50 rpm. The EVOH was melted at 193° C. in a 38.1 mm single screw extruder operating at 75 rpm. All four melt streams were fed through a Cloeren™ feedblock and die at 227° C. to cast onto chill rolls so as to form a five layer film with the LDPE at 10 microns on the drum side and 15 microns on the air side, the adhesive layers at 2.5 microns and the EVOH layer at 5.1 microns. The line speed was 65.7 m/min and the air gap or distance between the die and the chill roll was 38 mm.

In Process C, the adhesive blend compositions were co-extruded between an outer layer of conventional-HDPE of melt index 3 g/10 minutes, an inner layer of MDPE of 1.4 MI and 0.935 g/cc density, and a layer of ethylene/vinyl alcohol (EVOH) containing 32 mole % ethylene and a melt index of 1.6 g/10 min. The HDPE was melted at 232° C. in a 63.5 mm single screw extruder operating at 35 rpm. The adhesive blends were melted at 221° C. in a 50.8 mm. single screw extruder operating at 5 rpm. The EVOH was melted at 218° C. in a 38.1 mm single screw extruder operating at 35 rpm. The MDPE was melted at 246° C. at 50 rpm. All four melt streams were fed through a Cloeren™ feedblock and die at 249° C. to cast onto chill rolls so as to form a five layer film with the HDPE at 100 microns on the drum side and LLDPE at 92 microns on the air side, the adhesive layers at 7 microns and the EVOH layer at 25 microns. The line speed was 13 m/min and the air gap or distance between the die and the chill roll was 76 mm.

In Process D, the adhesive blend compositions were co-extruded between a layer of conventional-HDPE of MI 0.45 g/10 minutes, and a layer of ethylene/vinyl alcohol (EVOH) containing 32 mole % ethylene and a melt index of 1.6 g/10 min. The adhesive blends were melted at 214° C. in a 25 mm. single screw extruder operating at 56 rpm. The EVOH was melted at 231 ° C. in a 25 mm single screw extruder operating at 42 rpm. All three melt streams were fed through a Brampton™ co-extrusion blown film die so as to form a three layer film with the HDPE at 38 microns, the adhesive layer at 14 microns and the EVOH layer at 22 microns. The die temperature was 230° C. The blow-up ratio of the blown film, defined as the lay flat width of the film bubble divided by the diameter of the die opening, was 3.25. Blow-up ratio is sometimes defined in terms of final bubble diameter rather than lay flat ratio. By this definition, the ratio would be 2.1. The die gap was set at 0.508 mm or 508 microns. The draw down ratio was 2.53. The film was run at 3.7 to 4.3 m/minute through the take-up rolls. The lowest frost line height of the three frost lines in this three layer film was typically about 152.4 mm. The process time was calculated to be between 3.3 to 3.8 seconds.

The multilayer structures so prepared were evaluated by two different methods, depending on their thickness. The structures of 100 microns or less in thickness were cut into 13 mm wide strips and heat sealed with the thinner LDPE sides together at 132° C., 0.5 seconds at 40 pounds per square inch along their length. The heat sealed strips were then tested on an Instron™ tester at 152.4 mm/min to measure their peel strength. The test used three to five duplicates of each sample, and the average peel strength was reported on a 25 mm basis. The other structures of thickness over 100 microns were tested by measuring the peel strengths using ASTM D-1876-72, except that the test used only 3 duplicates of each sample rather than the specified 10. The test speed was 12 inches per minute (0.305 m/minute).

Table 3 shows examples of a five-layer laminate of PE/adhesive/EVOH/adhesive/PE made by three different processes. Examples 20 through 27 give high peel strengths. The laminates of comparative examples C20 and C21 were made using a low speed and slow quench process, described in Process C.

Table 3 shows examples of laminates made by a high speed and fast quench process A, including laminates containing nylon as the barrier layer and LDPE as the inner and outer layers. Examples 29, 30 and 31 are all adhesives containing an acid-modified metallocene PE blended into different conventional polyethylenes as base resin. The peel strength to nylon in these examples is much greater than that demonstrated in the comparative example (C22).

Table 2 shows examples of three layer laminates of HDPE, adhesive and EVOH made by a fast quench process D.

Examples 1 to 4 and C1 and C2 provide a comparison where the grafted resin, (metallocene or non-metallocene) in the laminate has comparable density in the 0.884-0.887 g/cc range. Examples 2 and 4 and C2 have an additional conventional-VLDPE component in the adhesive of the laminate.

In the laminates of Examples 5 and C3, the adhesives use grafted polyethylenes, the base resins for which have a somewhat higher density, approaching 0.9 g/cc. Examples 6 through 11 and C4 to C6 are laminates in which the adhesive use grafted metallocene and conventional resins whose density is lower; in the region of 0.87 g/cc. Examples 12 and 13 and C7 to C9 are laminates which use grafts based on higher density resins (0.902 and 0.907 g/cc) in the adhesive layer. The laminates in Examples 14 to 17 and C10 to C13 all incorporate LDPE in the non-grafted portion of the adhesive composition. The compositions cover a range of densities for the base component of the graft, as well as octene and butene copolymers as graft base resin. The laminate in Examples 18 uses a grafted relatively high density metallocene resin, while Example 19 uses a base metallocene resin which is a hexene copolymer in their adhesive layers.

TABLE 1
PROPERTIES OF COMPONENTS OF
POLYETHYLENE ADHESIVE BLENDS

| | MI | DENSITY | MI | | | |
|---|---|---|---|---|---|---|
| | (non-grafted | (non-grafted | (GRAFTED | % MAH | | |
| | PE) | PE) | PE) | (GRAFTED | | |
| CODE | g/10 min | g/cc | g/10 min | PE) | Mw/Mn | I10/I2 |
| G1-M | 2.2 | 0.887 | 5.7 | 0.83 | 1.9 | 5.64 |
| G2-M | 2.2 | 0.887 | 3.4 | 1.45 | 1.9 | 5.64 |
| G3-M | 1.0 | 0.902 | 3.5 | 0.98 | 2.2 | 8.62 |
| G4-M | 0.50 | 0.868 | 3.2 | 0.78 | 2.0 | 7.81 |
| G5-M | 2.5 | 0.935 | 3.0 | 1.01 | 2.0 | 9.71 |
| G6-M | 16.5 | 0.895 | 9.6 | 0.90 | 2.0 | 6.09 |
| G13-M | 1.6 | 0.899 | 2.3 | 1.02 | 2.1 | 9.89 |
| G5-C | 1.0 | 0.907 | 9.6 | 9.0 | 3.5 | 7.85 |
| G6-C | 1.0 | 0.907 | 2.5 | 1.0 | 3.5 | 7.85 |
| G7C | 1.0 | 0.907 | 4.9 | 0.90 | 3.5 | 7.85 |
| G8-C | 0.80 | 0.884 | 6.0 | 0.90 | 3.9 | 8.77 |
| G9-C | 12 | 0.895 | 28 | 0.70 | — | — |
| G12-C | — | 0.87 | 2.0 | 2.0 | — | — |
| GA-M | 3.5^{a} | 0.917^{a} | 2 | 0.9 | — | — |
| GC-C | 5^{a} | 0.959^{a} | 2 | 0.9 | — | — |
| GD-C | 1.4^{a} | 0.921^{a} | 2 | 0.9 | — | — |
| GB-M | 3.5^{a} | 0.917^{a} | 7 | 1.2 | — | — |
| LD | 15 | 0.915 | — | — | — | — |
| VLB | 13 | 0.895 | — | — | — | — |
| LDA | 15 | 0.915 | — | — | — | — |
| LLA | 5 | 0.924 | — | — | — | — |
| LDB | 12 | 0.924 | — | — | — | — |
| VLC | 3 | 0.898 | — | — | — | — |
| VLA | 0.8 | 0.884 | — | — | — | — |
| LL1 | 1.4 | 0.920 | — | — | — | — |
| LLB | 12 | 0.921 | — | — | — | — |

^{a}Property given is of base resin used in grafted PE.
LL1 is conventional LLDPE, 7 wt % (3.5 mol %) butene comonomer; manufactured by Novacor.
LLA = LL2 is conventional LLDPE, 7 wt % (3.5 mol %) butene comonomer.
LLB is conventional LLDPE, 7 wt % (3.5 mol %) butene comonomer.
VLA = VL1 is conventional-VLDPE, 23 wt % (13 mol %) butene comonomer; manufactured by Union Carbide.
VLB is conventional-VLDPE, 18 wt % butene/propylene comonomers (11.4 total mo %); manufactured by Enichem.
VLC is metallocene-VLDPE, 21.7 wt % (12 mol %) butene comonomer, manufactured by Exxon Corp.
LDA is LDPE.
MAH is maleic anhydride.
G1-M is graft onto metallocene resin with 19.5 wt % (10.8 mol %) butene comonomer manufactured by Exxon Corp.
G2-M is graft onto metallocene resin with 19.5 wt % (10.8 mol %) butene comonomer manufactured by Exxon Corp.
G3-M is graft onto metallocene resin with 13 wt % (3.5 mol %) octene comonomer manufactured by Dow Chem.
G4-M is graft onto metallocene resin with 25 wt % (7.6 mol %) octene comonomer manufactured by Dow Chem.
G5-M is graft onto metallocene resin with 3 wt % octene comonomer manufactured by Dow Chem.
G6-M is graft onto metallocene resin with 21 wt % (8.1 mol %) butene comonomer manufactured by Exxon Corp.
G5-C is graft onto conventional resin with 12 wt % (6.4 mol %) butene comonomer manufactured by Union Carbide.
G6-C is graft onto conventional resin with 12 wt % (6.4 mol %) butene comonomer manufactured by Union Carbide.
G7-C is graft onto conventional resin with 12 wt % (6.4 mol %) butene comonomer manufactured by Union Carbide.
G8-C is graft onto conventional resin with 23 wt % (13 mol %) butene comonomer manufactured by Union Carbide.
G9-C is graft onto conventional resin which is ethylene/propylene/butene copolymer, 4/14 wt % comonomers (11.4 total wt %) manufactured by Enichem.
G12-C graft onto a resin that is an EPDM elastomer containing 67 wt % ethylene.
G13-M graft onto metallocene resin with 16 wt % (4.5 mol %) octene comonomer base.
GA-M is graft onto metallocene resin with 8.3 wt % (2.9 mol %) hexene comonomer manufactured by Exxon Corp.
GB-M is graft onto metallocene resin with 8.3 wt % (2.9 mol %) hexene comonomer manufactured by Exxon Corp.
GC-C is graft onto conventional HDPE resin manufactured by Novacor.
GD-C is graft onto conventional HDPE resin manufactured by Novacor.

TABLE 2
EXAMPLES FROM PROCESS D

| | | | BLEND | Peel |
|---|---|---|---|---|
| Example | | | DENSITY | Strength |
| No. | BLEND* (wt %/wt %) | Wt % MAH | (g/cc) | (gm/25 mm) |
| 1 | G1-M/LL1 (15/85) | 0.124 | 0.915 | 190 |
| 2 | G1-M/LL1/VL1 (15/80/5) | 0.124 | 0.913 | 346 |
| 3 | G2-M/LL1 (8/92) | 0.118 | 0.917 | 417 |
| 4 | G2-M/LL1/VL1 (8/80/12) | 0.118 | 0.913 | 474 |
| 5 | G13-M/LL2(12/88) | 0.122 | 0.917 | 361 |
| 6 | G4-M/LL1 (15/85) | 0.117 | 0.912 | 486 |
| 7 | G4-M/LL2/VL1 (19/71/10) | 0.148 | 0.906 | 147 |
| 8 | G4-M/LL2/VL1 (19/61/20) | 0.148 | 0.902 | 666 |
| 9 | G4-M/LL2/EL1 (8/79/13) | 0.062 | — | 260 |
| 10 | G4-M/LL2/EL1 (19/76/5) | 0.148 | — | 445 |
| 11 | G4-M/LL2/EL1 (19/61/20) | 0.148 | — | 1338 |
| 12 | G3-M/LL1 (12/88) | 0.118 | 0.917 | 393 |
| 13 | G3-M/LL1/VL1 (12/76/12) | 0.118 | 0.913 | 450 |
| 14 | G1-M/LD1 (15/85) | 0.124 | 0.911 | 449 |
| 15 | G2-M/LD1 (8/92) | 0.116 | 0.913 | 216 |
| 16 | G3-M/LD1 (12/88) | 0.118 | 0.913 | 275 |
| 17 | G4-M/LD1 (15/85) | 0.117 | 0.908 | 454 |
| 18 | G5-M/LL1 (14.9/85.1) | 0.15 | 0.922 | 628 |
| 19 | G6-M/LL1 (15.6/84.4) | 0.12 | 0.916 | 452 |
| C1^{X} | G8-C/LL1 (13/87) | 0.117 | 0.915 | 86 |
| C2^{X} | G8-C/LL1/VL1 (13/80/7) | 0.117 | 0.913 | 168 |
| C3^{X} | G9-C/LL1 (12/88) | 0.84 | 0.917 | 53 |
| C4^{X} | G12-C/LL1 (6/94) | 0.12 | 0.917 | 47 |
| C5^{X} | G12-C/LL2/VL1 (8.5/74.5/17) | 0.17 | 0.909 | 113 |
| C6^{X} | G12-C/LL2/EL1 (8.5/86.5/5) | 0.17 | — | 37 |
| C7^{X} | G5-C/LL1 (13/87) | 0.117 | 0.918 | 104 |
| C8^{X} | G6-C/LL1 (12/88) | 0.12 | 0.918 | 313 |
| C9^{X} | G7-C/LL1 (13/87) | 0.117 | 0.918 | 126 |
| C10^{X} | G8-C/LD1 (13/87) | 0.117 | 0.911 | 159 |
| C11^{X} | G5-C/LD1 (13/87) | 0.117 | 0.914 | 148 |
| C12^{X} | G6-C/LD1 (12/88) | 0.12 | 0.914 | 216 |
| C13^{X} | G12-C/LD1 (15/85) | 0.117 | 0.908 | 454 |

*See Table 1 for code definitions.
EL1 is an EPDM elastomer with 70 wt % ethylene, and Mooney viscosity of 21.
ELA is an ethylene/propylene/ethylidene-norbornene elastomerwith 70 wt % ethylene and Mooney viscosity of 20.
ELB is an ethylene/propylene/hexadiene elastomer with 70 wt % ethylene and Mooney viscosity of 21.
^{X}Not an example of the present invention.

TABLE 3
EXAMPLES FROM PROCESSES A, B AND C

| | | | Film | Peel |
|---|---|---|---|---|
| Example | | Wt % | Thickness | Strength |
| No. | BLEND* (wt %/wt %) | MAH | (microns) | (gm/25 mm) |
| 20 | GA-M/LD/VLB (23/67/10) | 0.21 | 35^{A} | 1498 |
| 21 | GA-M/LD/ELA (25/65/10) | 0.23 | 35^{A} | 1471 |
| 22 | GA-M/LD/VLB (15/60/25) | 0.14 | 35^{A} | 1244 |
| 23 | GA-M/LDA/VLB (15/75/10) | 0.14 | 35^{A} | 281 |
| 24 | GA-M/VLB (25/75) | 0.23 | 35^{A} | 1530 |
| 25 | GA-M/LLA/VLB (25/50/25) | 0.23 | 35^{A} | 1553 |
| C14^{X} | GC-C/LDA/VLB (25/65/10) | 0.23 | 35^{A} | 150 |
| C15^{X} | GC-C/LDA/VLB (15/60/25) | 0.14 | 35^{A} | 174 |
| C16^{X} | GC-C/LDA/ELB (25/52/23) | 0.23 | 35^{A} | 204 |
| C17^{X} | GD-C/LLA/LDB/VLC (12/14/44/30) | 0.11 | 35^{A} | 254 |
| 26 | GB-M/LLA/LDA (19/71/10) | 0.23 | 35^{A} | 1342 |
| 27 | GB-M/LLA/LDA (11/79/10) | 0.14 | 35^{A} | 274 |
| C18^{X} | GC-C/LLA (12/88) | 0.11 | 35^{A} | 122 |
| 28 | GA-M/LDA/VLA/VLB (15/60/5/20) | 0.14 | 50^{B} | 1543 |
| C19^{X} | GC-C/LDA/ELB (25/52/23) | 0.23 | 50^{B} | 319 |
| C20^{X} | GA-M/LL1/LLB/LDA/ELB (15/32/25/5/23) | 0.14 | 230^{C} | 4143 |
| C21^{X} | GC-C/LLB/LDA/ELA (25/47/5/23) | 0.23 | 230^{C} | 4609 |
| 29^{y} | GA-M/LD/VLB (15/60/25) | 0.14 | 35^{A} | 1426 |
| 30^{y} | GA-M/VLB (25/75) | 0.23 | 35^{A} | 1462 |
| 31^{y} | GA-M/LLA/VLB (25/50/25) | 0.23 | 35^{A} | 1512 |
| C22^{X,y} | GC-C/LDA/ELB | 0.23 | 35^{A} | 250 |

*See Table 1 for code definitions.
EL1 is an EPDM elastomer with 70 wt % ethylene, and Mooney viscosity of 21.
ELA is an ethylene/propylene/ethylidene-norbornene elastomerwith 70 wt % ethylene and Mooney viscosity of 20.
ELB is an ethylene/propylene/hexadiene elastomer with 70 wt % ethylene and Mooney viscosity of 21.
^{A}Made by Process A.
^{B}Made by Process B.
^{C}Made by Process C.
^{X}Not an example of the present invention.
^{y}Laminate includes nylon.

1. A coated article obtained by a rapid melt co-extrusion coating process wherein the coating comprises at least one structural layer, at least one adhesive layer and optionally at least one barrier layer wherein the adhesive composition, comprises:
a) a polyethylene selected from the group consisting of conventional-HDPE, conventional-MDPE, conventional-LLDPE, conventional-VLDPE, LDPE, and a blend of any of these five,
b) from 5 to 35 weight percent, based on the total weight of a) plus b) plus c), of an acid-grafted substantially linear polyethylene, c) optionally up to 30 weight percent of a hydrocarbon elastomer,
the acid grafting agent being an unsaturated carboxylic acid or its derivative, and the level of grafting being such that the total amount of grafting agent in the total composition a) plus b) plus c) is from 0.01 to 3 weight percent, and wherein the coating is applied at a process line speed in the range of from about 50 m/min to about 950 m/min, and an air gap in the range of from about 10 mm to about 500 mm.

2. The laminate of claim 1 wherein the line speed is in the range of from about 80 to about 800 m/min.

3. The laminate of claim 2 wherein the line speed is in the range of from about 100 to about 600 m/min.

4. The laminate of claim 3 wherein the line speed is in the range of from about 100 to about 400 m/min.

5. The laminate of claim 4 wherein the air gap is in the range of from about 75 to about 500 mm.

6. The laminate of claim 5 wherein the air gap is in the range of from about 100 to about 450 mm.

7. The laminate of claim 6 wherein the air gap is in the range of from about 120 to about 350 mm.

8. A coated article obtained by a rapid melt co-extrusion cast film process wherein the cast film comprises at least one structural layer, at least one adhesive layer and optionally at least one barrier layer wherein the adhesive composition, comprises:
a) a polyethylene selected from the group consisting of conventional-HDPE, conventional-MDPE, conventional-LLDPE, conventional-VLDPE, LDPE, and a blend of any of these five;
b) from 5 to 35 weight percent, based on the total weight of a) plus b) plus c), of an acid-grafted substantially linear polyethylene; and c) optionally up to 30 weight percent of a hydrocarbon elastomer,
the acid grafting agent being an unsaturated carboxylic acid or its derivative, and the level of grafting being such that the total amount of grafting agent in the total composition a) plus b) plus c) is from 0.01 to 3 weight percent, and wherein the coating is applied at a process line speed in the range of from about 50 m/min to about 400 m/min, and an air gap in the range of from about 12 mm to about 150 mm.

9. The laminate of claim 8 wherein the line speed is in the range of from about 60 to about 300 m/min.

10. The laminate of claim 9 wherein the line speed is in the range of from about 70 to about 300 m/min.

11. The laminate of claim 10 wherein the line speed is in the range of from about 100 to about 250 m/min.

12. The laminate of claim 1 1 wherein the air gap is in the range of from about 25 mm to about 75 mm.

13. The multilayer laminate of claim 1 wherein the structural layer is selected from the group of ethylene homopolymers, ethylene copolymers and ethylene ionomers.

14. The multilayer laminate of claim 1, wherein at least one layer is a barrier layer to oxygen, water, or both.

15. The multilayer laminate of claim 14 wherein the barrier layer is an ethylene vinyl alcohol polymer or a nylon polymer or both.

16. The multilayer laminate of claim 1 wherein the adhesive component b) is less than 30 weight percent of the total adhesive composition, and the amount of grafting agent is from 0.05 to 0.25 weight percent of the total composition a) plus b) plus c).

17. The multilayer laminate of claim 1 wherein the adhesive component b) is melt-blended prior to coextrusion.

18. The multilayer laminate of claim 1 wherein the adhesive component b) is dry-blended and melt mixed during extrusion.

19. The multilayer laminate of claim 8 wherein the structural layer is selected from the group of ethylene homopolymers, ethylene copolymers and ethylene ionomers.

20. The multilayer laminate of claim 8, wherein at least one layer is a barrier layer to oxygen, water, or both.

21. The multilayer laminate of claim 20 wherein the barrier layer is an ethylene vinyl alcohol polymer or a nylon polymer or both.

22. The multilayer laminate of claim 8 wherein the adhesive component b) is less than 30 weight percent of the total adhesive composition, and the amount of grafting agent is from 0.05 to 0.25 weight percent of the total composition a) plus b) plus c).

23. The multilayer laminate of claim 8 wherein the adhesive component b) is melt-blended prior to coextrusion.

24. The multilayer laminate of claim 8 wherein the adhesive component b) is dry-blended and melt mixed during extrusion.

25. An adhesive composition, useful in a rapid composite film fabrication process, comprising: from about 5 percent to about 35 percent, by weight, acid-grafted substantially linear polyethylenes; a conventional-linear polyethylene and/or a LDPE based adhesive composition.
